(19) United States
(12) Patent Application Publication
(10) Pub. No.: US 2022/0345427 A1
(43) Pub. Date: Oct. 27, 2022

(54) SYSTEM AND INTERFACES FOR TRACKING ASYNCHRONOUS COMMUNICATIONS

(71) Applicants: Anthony J. Longo, JR., Jamestown, RI (US); Robert Salvatore Breznak, Jamaica Plain, MA (US)

(72) Inventors: Anthony J. Longo, JR., Jamestown, RI (US); Robert Salvatore Breznak, Jamaica Plain, MA (US)

(21) Appl. No.: 17/730,685

(22) Filed: Apr. 27, 2022

Related U.S. Application Data
(60) Provisional application No. 63/270,731, filed on Oct. 22, 2021.
(60) Provisional application No. 63/180,401, filed on Apr. 27, 2021.

(51) Int. Cl. H04L 51/046; H04L 67/50; H04L 67/306; G06Q 30/04

(52) U.S. Cl. CPC H04L 51/046; H04L 67/535; H04L 67/306; G06Q 30/04

(57) ABSTRACT

An integration component is provided that integrates with standard applications such as chat, email, and the like, that is configured to record a user's time and effort in communicating and/or executing an application, such as on a computer, mobile phone and the like. Such time may be used to compute charges for services in an automated way and may trigger other controls that allow other users to purchase further services from the providing user.

This application is a Non-Provisional of Provisional (35 USC 119(e)) of U.S. Application Ser. No. 63/270,731, filed Oct. 22, 2021, entitled “SYSTEM AND INTERFACES FOR TRACKING ASYNCHRONOUS COMMUNICATIONS” and is a Non-Provisional of Provisional (35 USC 119(e)) of U.S. Application Ser. No. 63/180,401, filed Apr. 27, 2021, entitled “SYSTEM AND INTERFACES FOR TRACKING ASYNCHRONOUS COMMUNICATIONS”. The entire contents of these applications are incorporated herein by reference in their entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

Systems exist that permit users to interact with each other in a variety of ways, including messaging, videoconferencing, email, and the like.

### SUMMARY

It is appreciated herein that most people interact with each other asynchronously. For example, a first user sends a message to a second user that is responded to sometime later, not usually in a bounded timeframe. In some embodiments described herein, it is appreciated that it would be helpful and more efficient use of a user's time to record a user's effort in performing asynchronous communications. It would also be helpful to be able to record live communications as well within a single system. In some roles or professions (e.g., a service provider user such as a consultant, expert, an attorney, or other service provider), it would be helpful to track a user's effort as they use such applications in a distributed computer network. In some cases, there may be provided an integration component to standard applications such as chat, email, and the like, that is configured to record a user's time and effort in communicating and/or executing an application, such as on a computer, mobile phone and the like. Such time may be used to compute charges for services in an automated way and may trigger other controls that allow other users to purchase further services from the providing user.

According to some embodiments, a distributed communication system is provided that is configured to:
Ability to accurately calculate time for asynchronous messaging between users
   Text (e.g., averaging around how fast one can read and understand)
   Audio (e.g., message length×# times listened, paused, etc.)
   Video (e.g., message length×# times watched, paused, etc.)
   Photo (e.g., time opened on screen, viewed, etc.)
Tying this calculation to a “time-boxed” transaction or rate card set by the service provider (e.g., expert, influencer, professional service provider, etc.)

Models can be used that are adaptable and may be mapped to conventional payment arrangements:
Hourly rates, weekly/monthly retainers
Project scoped work (fee for deliverable)
Standard salary
Standard punch card type employment
Other arrangements

For instance, it is appreciated that there may be opportunities to engage with an expert, influencer or professional during their free time without knowing or having to schedule a time for a real time engagement. Further, it is appreciated that it may be helpful to the expert, influencer or professional to be able to clearly understand the question or request for advice using various asynchronous communication types and therefore be able to provide the answer or advice to the customer in a much more cost-efficient manner than a traditional 1-on-1 “live” consulting session. For instance, a Facebook Ads Marketing Specialist, who typically charges $400/hour or $10,000/month could field a question from a consumer for a much smaller rate of $50 for 5-minutes of asynchronous consulting. Both the customer and the Facebook Ads Marketing Specialist benefit from this type of engagement. The customer benefits because they are able to access a top-level professional at an affordable rate by trading a “live” interaction for an asynchronous interaction and the Facebook Ads Marketing Specialist benefits because they are able to charge and higher price per minute for the smaller time window. Both parties also benefit from the “frictionless” environment of not having to coordinate calendars and book a scheduled time.

Further, it is appreciated that there are existing systems that perform cost recovery for expert time. However, such systems are intrusive, and require additional user steps to perform (e.g., by the expert) such as inputting account or chargeback information. In some embodiments, a singular system is provided that non-intrusively tracks effort spent by an expert among a number of computer applications, and bills accordingly. Further, according to some embodiments, as the system is capable of working within the user application without needing to leave the application interface, user efficiency is improved and requiring less user operations. Further, the system may be capable of inferring user activity (e.g., by an expert) in order to more accurately capture that user's effort.

According to one aspect a system is provided. The system comprises an end user application that permits asynchronous communications between a service provider user and a consumer user, a time-based component that is configured to calculate a time of use by the service provider user of the end user application, and a billing component adapted to charge a user based on the calculated time of use. According to one embodiment, the end user application is at least one of a group comprising a chat application, a messaging application, a conferencing application, and an application by which the service provider user creates content.

According to one embodiment the system further comprises at least one user interface that is adapted to display the time of use by the service provider user of different end user applications. According to one embodiment the system further comprising a first end system adapted to execute a first end user application, the first end user application being operable to receive content generated by the service provider user. According to one embodiment, the time-based component is adapted to map activity of the service provider user within the first end user application into at least one billing contract between the service provider user and the consumer user.

According to one embodiment the system further comprising a component configured to measure activity of the service provider user within the first end user application. According to one embodiment, the component that measures the activity of the service provider user includes at least one of a group comprising: a component configured to estimate activity based on heuristics, a component adapted to learn activity responsive to training, a component configured to estimate activity based on statistical methods, and a component configured to estimate activity based on content shared within the first end user application.

According to one embodiment, the component that measures the activity of the service provider user includes a timer that is adapted to count down responsive to a detection of presence of activity of the service provider user within the first end user application. According to one embodiment, the timer is adapted to stop counting down responsive to a detection of an absence of presence of activity of the service provider user within the first end user application. According to one embodiment, the timer is adapted to count down responsive to a determination that the service provider user is operating within an active viewport of the first end user application. According to one embodiment, the timer is adapted to count down responsive to an activation of a control by the service provider user within the first end user application. According to one embodiment, the timer is adapted to count down responsive to an activation of a second end-user application executing on the first end system.

According to one embodiment, the second end-user application includes at least one of a group comprising: a chat application, a messaging application, a conferencing application, and an application by which the service provider user creates content. According to one embodiment, the time-based component and billing component are separate from the second end-user application. According to one embodiment, the time-based component and billing component are integrated into multiple end-user applications to measure the activity of the service provider user.

According to one embodiment, the timer is adapted to stop counting down responsive to a detection of the service provider leaving an active communication thread between the service provider user and the consumer user. According to one embodiment, the timer is adapted to stop counting down responsive to a detection of an interruption within the interface of the first end system. According to one embodiment, the end user application includes at least one interface control that permits either the service provider user or the consumer user to invite another user to join the asynchronous communications. According to one embodiment, the end user application includes at least one interface control that permits a third-party user to access the asynchronous communications between the service provider user and the consumer user. According to one embodiment, the end user application includes at least one interface control that permits a third-party user to access a message thread between the service provider user and the consumer user. According to one embodiment the system further comprising a second end system adapted to execute a second end user application, the second end user application being operable to display content generated by the service provider user to the consumer user.

According to one aspect a method is provided. The method comprises acts of executing, by a first end system, a first end user application being operated by a service provider user, executing, by a second end system, a second end user application being operated by a consumer user, and managing asynchronous communication between the first end user application and the second end user application, the act of managing further comprising acts of: calculating, by a time-based computing entity, a time of use by the service provider user of the first end user application, and charging, by a computer-based billing entity, the consumer user based on the calculated time of use.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples and are incorporated in and constitute a part of this specification but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of a distributed computer system capable of implementing various aspects;

FIG. 2 shows an example process for performing asynchronous communication according to various embodiments;

FIG. 3 shows an example system architecture for managing asynchronous communication according to various embodiments;

FIGS. 4A-4D shows another example process for performing asynchronous communication according to various embodiments;

FIG. 5 shows an example user interface used for performing asynchronous communication according to various embodiments;

FIG. 6 shows another example user interface used for performing asynchronous communication according to various embodiments;

FIG. 7 shows an example user interface used for performing asynchronous communication according to various embodiments;

FIG. 8 shows an example user interface used for extending an asynchronous communication session according to various embodiments;

FIG. 9 shows an example user interface used for performing asynchronous communication according to various embodiments;

FIG. 10 shows one example implementation of a coordination and timing between an expert client and a customer client according to some embodiments;

FIG. 11 shows one example implementation of an attention tracking system according to some embodiments;

FIG. 12A shows an example user interface used for performing asynchronous communication according to various embodiments;

FIG. 12B shows an example user interface used for performing asynchronous communication according to various embodiments; and

FIG. 12C shows an example user interface used for performing asynchronous communication according to various embodiments.

### DETAILED DESCRIPTION

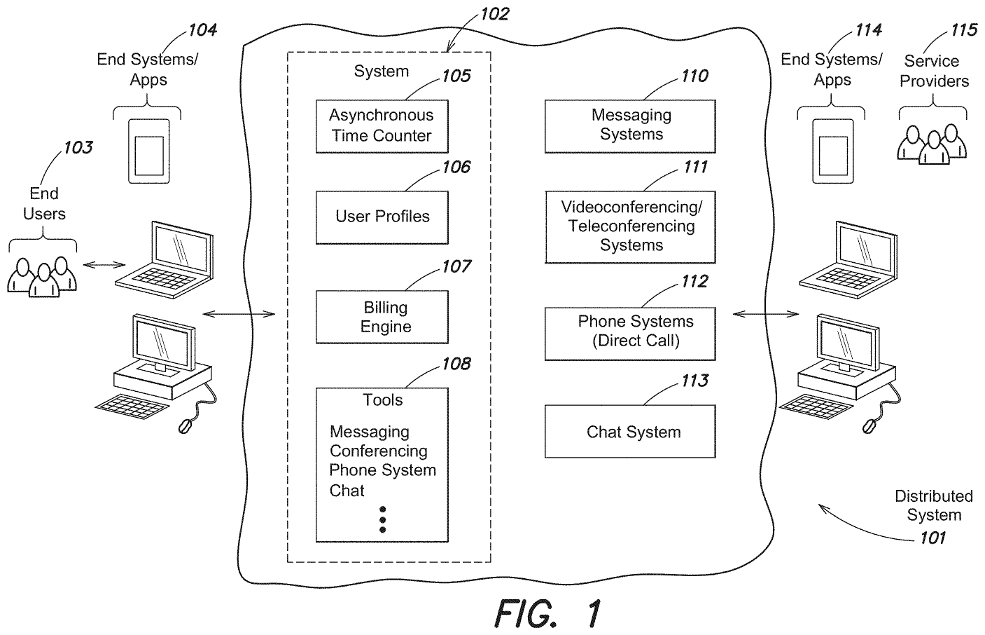

FIG. 1 shows a block diagram of a distributed computer system 101 capable of implementing various aspects. In particular, distributed system 101 includes one or more computer systems (e.g., end systems and their associated applications 104) operated by end users and access services through a communication network (e.g., the Internet). Generally, users may access the distributed system through a client application that is executed on one or more of end systems (e.g., end user system 104). End user systems 104 may be, for example, a desktop computer system, mobile device, tablet or any other computer system having a display and may have one or application programs executing upon them that are capable of performing asynchronous messaging operations.

As discussed, various aspects of the present invention relate to managing and recording asynchronous communications for the purpose of determining effort provided by service providers which can be translated into a bill-back system to the users that have received the services. The system may be integrated with standard messaging platforms (e.g., chat services, Slack, email, etc.).

To this end, service provider users may also communicate using the distributed system 101 with service-receiving users (e.g., end users 103) via a system that manages and tracks the asynchronous communications. Service provider users (e.g., service providers 115) may access system 101 via one or more end systems and their associated applications (e.g., end systems/apps 114).

System 102 includes one or more systems that performs one or more computer-based operations according to various embodiments to facilitate tracking of asynchronous communications between users. In particular, system 102 includes a number of components that may be used to perform tracking between users performing asynchronous (and in some embodiments, both asynchronous synchronous) communications. System 102 includes an asynchronous time counter 105 that calculates time spent by service providers in communications, use of applications, viewing of content, and other actions that consume a service providers time.

System 102 may also include a number of user profiles 106 which can be associated with one or more end users and/or service providers. In some cases, service providers may be permitted to configure various agreements associated with the services that they provide, and control how a user client is charged for the service provider use of various digital communication methods. In some cases, algorithms may be used to determine how a particular service provider may comprehend information and effectively communicate back to the user.

System 102 may also include a billing engine 107 which is capable of translating time counter information to various billing arrangements that service providers may have with particular users. For example, the system may use any number of different types of billing arrangements and translate the effort expended by the service provider to map into that arrangement. For instance, there may be a fixed fee associated with certain time-based measures (e.g., an hourly rate) to which a user may be charged. Further, there may be fixed rates for particular efforts, milestones, or other achievements, and the service providers use of the computer-based applications may be mapped into those particular efforts. In one example, when a particular deliverable is achieved, the billing engine may charge a user's credit card for the service.

System 102 may also include one or more tools 108 that integrate or otherwise provide services for messaging, conferencing, phone connections, chat, or other type of synchronous or asynchronous services that may be used between users. System 102 may also integrate with one or more conventional messaging systems (e.g., messaging systems 110), videoconferencing or other type systems (e.g., videoconferencing/teleconferencing systems 111), phone systems (e.g., phone systems 112), chat systems (e.g., chat system 113) or any other type of system that is used to communicate between users. In some implementations, system 102 may be integrated with different platforms for messaging to measure efforts within such platforms, such as email systems, SMS, Slack, IoT or other communication frameworks. In some embodiments, a platform is provided that operates across platforms and different computer systems for the purpose of performing measurements of time and performing the associated billing function associated with a particular service provider user.

In some implementations, system 102 may include one or more components that track and call the various systems that are used by service providers to provide the service. In some cases, the tools may measure and/or analyze the content provided between the systems. In one example, the system may gauge the length and complexity of a particular document, video, image, or other media type that may be part of an asynchronous communication. Where actual use and time spent by service providers cannot be directly measured, it may be estimated using heuristics, artificial intelligence/machine learning, statistical analysis methods (e.g., regression), or other methods. In some embodiments, a machine learning engine may be provided that determines a calculated time value (or other measure of effort) based on training for a particular user or groups of users.

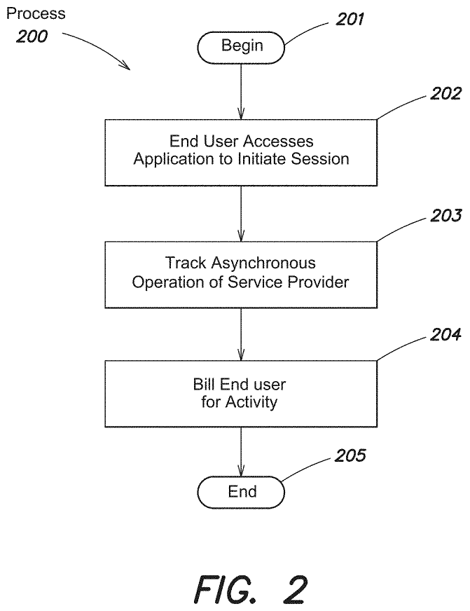

FIG. 2 shows an example process for performing asynchronous communication according to one embodiment of the present invention. At block 201, process 200 begins. At block 202, an end user accesses an application to initiate a session between the user and the service provider user. For example, this may be accomplished through selecting a link in a website or selecting a control within an application program. In some embodiments, a separate application may be provided that connects end-users and service providers within an ecosystem (e.g., a marketplace application).

At block 203, the system tracks the asynchronous operation of a service provider. Such operations may include the service provider receiving and analyzing a document, viewing the video, creating responses and/or additional content for the user to further the providing of the service. If the service is complete, or the service reaches a particular milestone, the system may automatically bill the end user for particular activity at block 204. In some instances, such as in time-based billing, a user may be charged as the activity is performed and completed (e.g., review of a particular document). In some cases, time may be aggregated by the system for various activities and a billing event may occur (e.g., at the conclusion of a service provider activity, a monthly time period, or other type of event that may be tracked by the system). At block 205, process 200 ends.

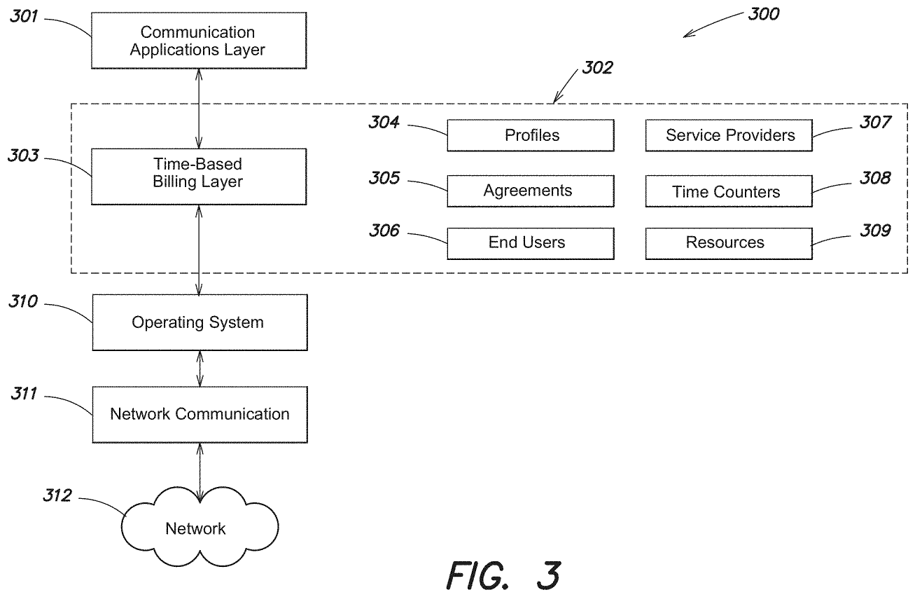

FIG. 3 shows an example system architecture for managing asynchronous communication according to some embodiments. For example, a system architecture may be provided that integrates with one or more communication applications for the purposes of tracking digital communications between service provider users and service receiving users. For example, in architecture layer 302 may include a time-based billing layer 303 that tracks actions performed between communication applications and other users via an operating system 310, network communication 311, and network 312.

In particular, the time-based billing layer 303 may be configured to monitor service providers use of applications for various communications between particular and users. To this end, layer 302 may include various parameters and configurations for the different services, users, and service providers that may be used by the system. In particular, layer 302 may track different profiles 304, agreements 305, end-users 306, service providers 307, time counters 308, and resources 309. For example, there may be different preferences and configurations for different types of users such as and users 306 and service provider 307. There may also be different time counters 308 that may be used for certain activities which are either directly measured or estimated based on heuristics or intelligence. Further, layer 302 may also include some aspects that integrate with communication applications layer to facilitate tracking of communications between users.

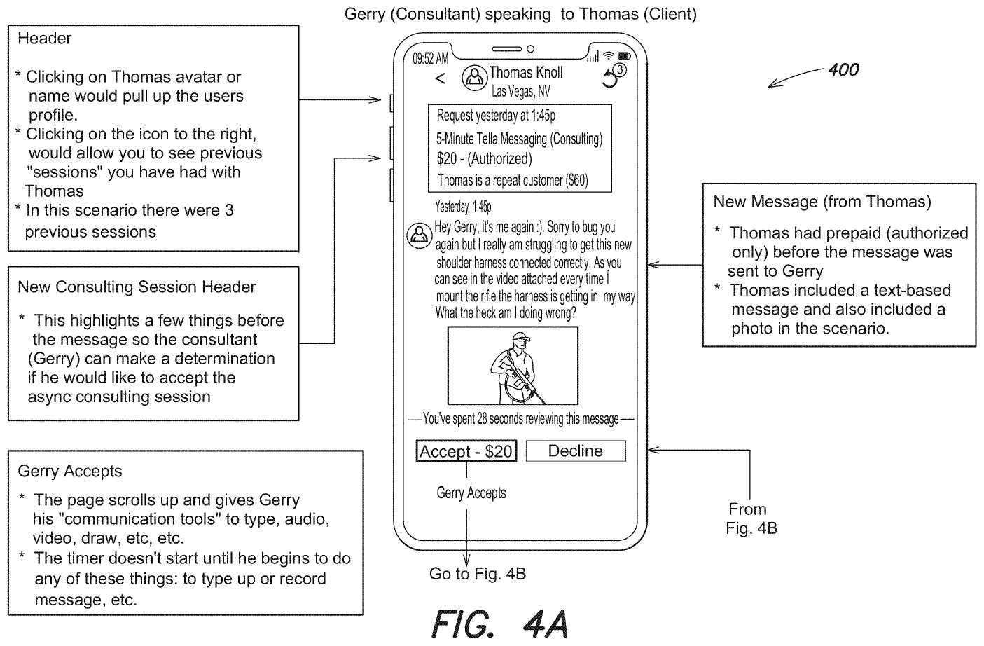

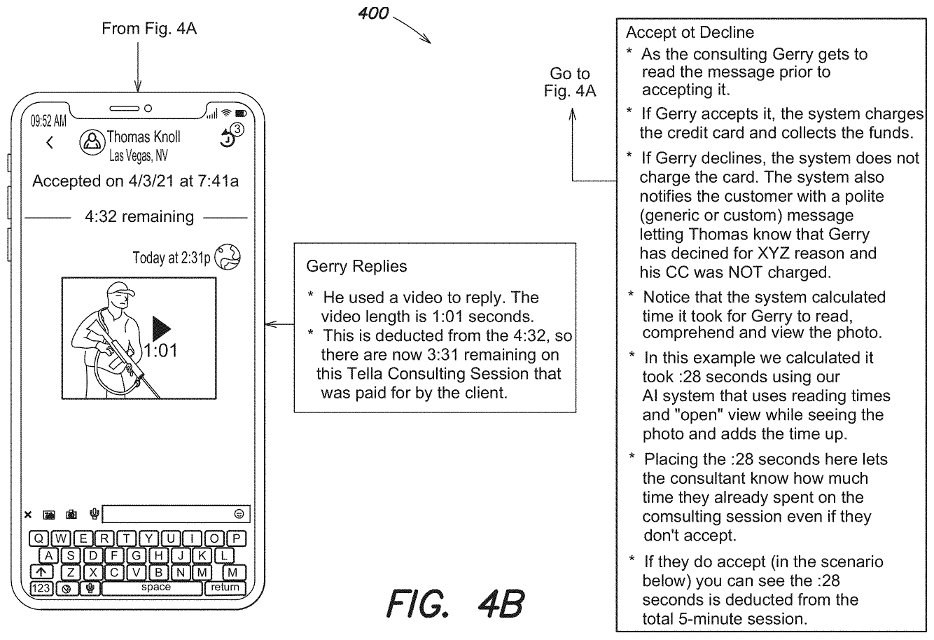

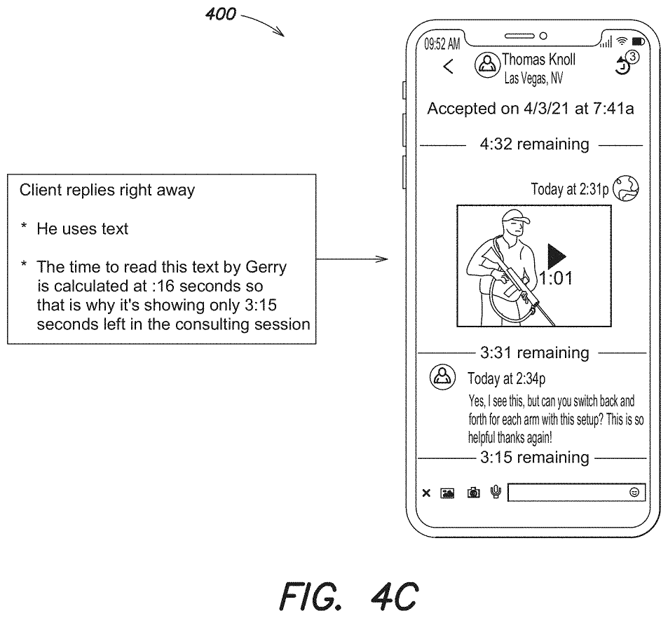

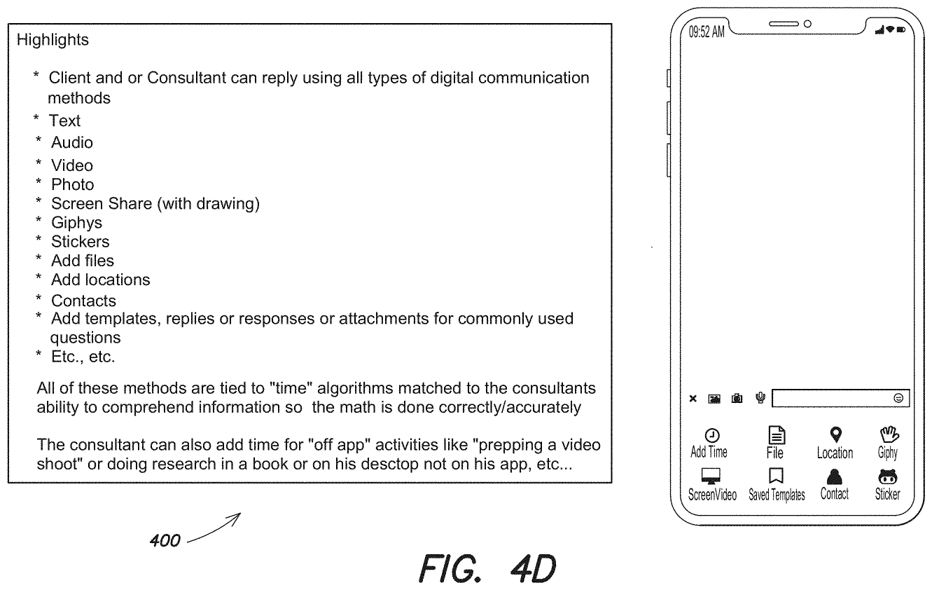

FIGS. 4A-4D shows another example process 400 for performing asynchronous communication according to various embodiments. For example, as shown in FIG. 4A, a service provider user (a consultant) Gerry is providing a service to a user Thomas (e.g., a client). In some embodiments, an application is provided that includes controls that, when activated by the user, measures activity by the service provider user with respect to a consumer user. For example, the user Gerry may select a user avatar that represents Thomas which pulls up information on the user (e.g. a profile). The system may include controls that allow the user to review previous sessions that the service provider user had with the particular consumer user. In one example, the consultant user (Gerry) accepts and a sink consulting session with a user Thomas.

If accepted, a new interface may be presented that permits the service provider user to use his communication tools to type, audio, video, draw, or provide other information within various communication applications or channels. In FIG. 4B, as one example, Gerry uses a video to reply, and the video length is 1:01 seconds. In the case that 4:32 was remaining as being pre-authorized, this amount of time may be deducted from the session that was previously paid for by the client. In some embodiments, the user interface may indicate the amount of time that is remaining for the consulting session, and the system may automatically deduct from this time based on different actions that were performed within the interface. In some embodiments, the system may maintain a timer that counts down from a time remaining within the interface. In the case of a chat interface, the timer may count down when the user is active within the particular chat thread. When the user stops the chat application or switches to a different thread, the timer may be frozen. In this way, time may be more accurately tracked for the user session.

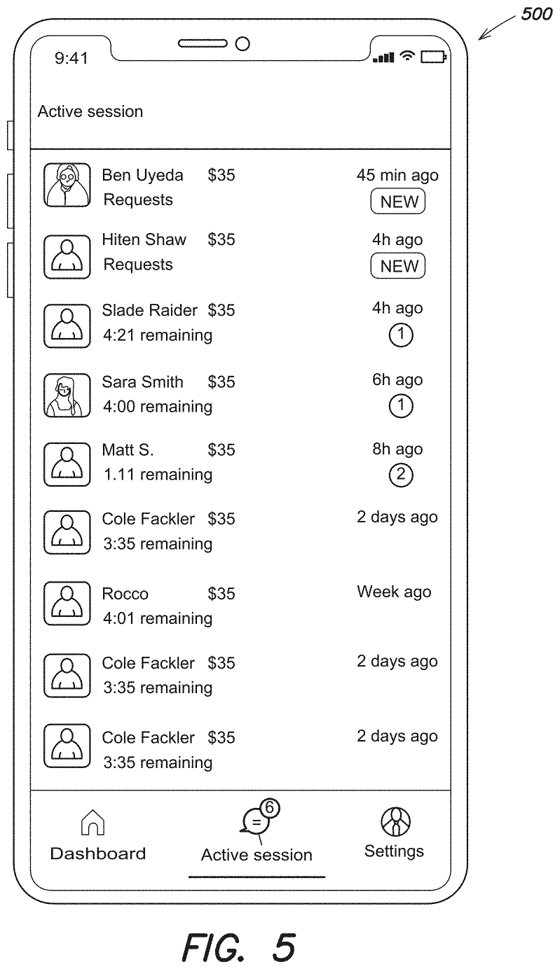

FIG. 4C shows that a client views the video and replies back using text. The system in this case determines that the time to read the text by the consultant Gerry is calculated to be 16 seconds and subtracts the amount from the 3:31 remaining in the consulting session. FIG. 4D shows other interfaces and activities that may be performed by the service provider user. As shown, users may be permitted to use all types of digital communication methods which are tied to time-based algorithms that in some embodiments, are matched to a consultant's ability to comprehend information so that time-based billing is performed more correctly and/or accurately. Further, effort may be tracked for other activities that are separate from the asynchronous communication such as performing research, doing other activities outside of the applications or other efforts. Other example interfaces (e.g., discussed further below with respect to FIGS. 5-9) show additional interface examples that may permit asynchronous activity to be tracked according to various embodiments.

### Example Timing Implementation

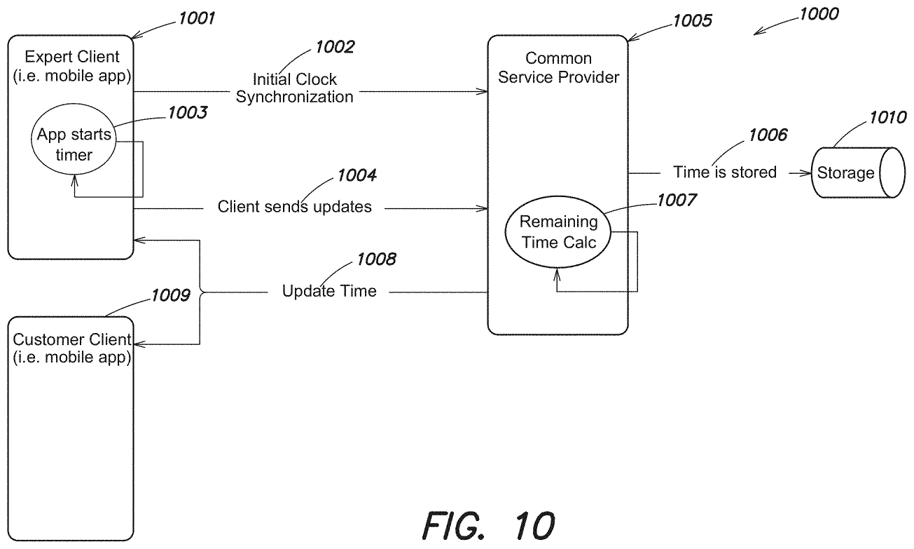

FIG. 10 shows one example implementation of a coordination and timing between an expert client 1001 and a customer client 1009 according to some embodiments. For instance, a process 1000 may be performed between an expert client system 1001 (e.g., a mobile application executing on an expert's mobile phone) that is in communication with a customer client system 1000 (e.g., a mobile application executing on a client's mobile phone). At step 1002, an initial clock synchronization is performed (this may be an optional step) between the expert client (e.g., the app) and a common service provider (e.g., email system, a system that manages and tracks the asynchronous communications, Slack or other messaging system, etc.). For example, the synchronization operation may be performed using, for example, an HTTP request, a websocket, a TCP/IP connection, a UDP broadcast or some other communication method.

At step 1003, the application (“app”) starts a timer. This timer may be based on, but not limited to, an active viewport (i.e., is the customer's conversation in view), an expert interaction (i.e., the expert clicking a “start time” button), an inferred action (i.e., launching a Zoom link with the customer by the expert), the app sending periodic session updates to the backend, among others or any combination of interacting functions. In some embodiments, updates can be (but not limited to) based on times are relative to the client (i.e., Start Time Local timestamp XX/End Time timestamp YY), absolute times (i.e., 45 seconds), backend stores time appropriately, etc. In some embodiments, the common service provider 1005 stores time (e.g., at step 1006) within a hard disk, database, memory location, in-memory session or other storage structure (e.g., in storage 1010).

At step 1007, any necessary time calculations are performed to determine the remaining time (e.g., additions, subtractions, etc.). At step 1008, any relevant clients are updated, including, but not limited to, the customer app(s) (e.g., more than one customer can be served at a time), the expert app(s) (more than one expert may be in a session, a third-party app, or other interface type.

### Attention Tracking

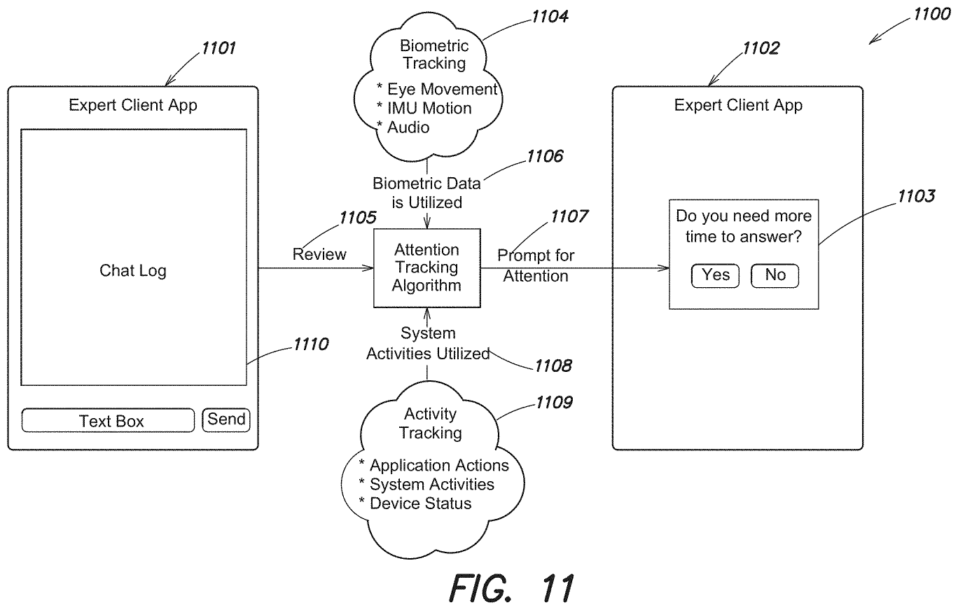

In some embodiments, the system may use one or more components that track the attention of the expert user. For instance, while operating a client application, the system may read one or more signals that indicate the expert is performing actions relating to a particular user session. FIG. 11 shows one example implementation of an attention tracking system according to some embodiments.

For example, the system may display to the expert (e.g., in an expert client app 1101) a chat log 1110 within the display. As the expert reviews the conversation within the chat log, one or more aspects of the expert's attention may be monitored. For example, an attention tracking algorithm may determine that the expert user is reviewing the chat log using one or more signals, including biometric data 1106.

For instance, biometric tracking may be performed by the application or some other system associated with the end system being operated by the expert (e.g., a mobile phone, PC, laptop, etc.). A biometric tracking entity 1104 may be provided that tracks biometric activity of the expert user. For example, the system may track device-monitored activities such as eye movement/focus, facial position, motion (e.g., via inertial measurement unit (IMU)), audio, among other environmental measurements.

Further, other activity tracking may be detected by an activity tracking entity 1109 which provides system activity information to the attention tracking algorithm. For instance, the system may detect application actions, system activities, the device status, among other information to determine system and application activities (e.g., is there typing occurring, is the device sleeping, etc.). The attention tracking algorithm may employ one or more models (e.g., machine learning algorithms, rulesets, statistical functions, weighting, etc.) to determine, based on the received signals, what the expert is currently doing. In one specific example, if the system detects a threshold of inattention (i.e., detection of “no face” in the direction of the screen), the application may pause the session. In some embodiments, the system may use an interface to prompt the expert user to continue the session (e.g., by displaying a popup prompt 1103 within the expert client app 1102). In this manner, the system is capable of simplifying the number of user actions to operate the tracking system.

### Example Implementations

In one example implementation, the user can engage with the platform through using other communication platforms. For example, a user may be in the “Slack” application at his company, and with the command is able to access an external person who is an expert on the platform. This may be performed, for example, on the communication platform using one or more types of messages such as an iMessage, email, other chat messengers, etc.

For example, when a user is in the “Slack” application, the user may enter a/command such as “/five aws” which then causes the system to access a list of experts on the platform who specialize in “aws.” The user is then permitted to choose one expert and can message the expert while within the Slack platform. The system will contact the expert through the communication platform and monitor the “time” within the chat. When in operation, the chat goes back and forth through the timing and billing platform where the system monitors, measures, estimates and calculates the timer until the chat is concluded. According to some aspects of various implementations, the user is operating within the native application (e.g., Slack) and the communication with experts is conducted within the application seamlessly without having to leave the application.

In some example implementations, a simple counter may also be used. When an expert enters a message thread for a particular conversation, the platform begins to reduce time on the clock. When the expert leaves the thread, the timer is paused. The timer may also pause when the system senses inactivity (e.g. the expert could have received a phone call, was interrupted, may need to place a phone down while still in an active thread, etc.). In some embodiments, the timer is paused after a predetermined number of seconds of inactivity.

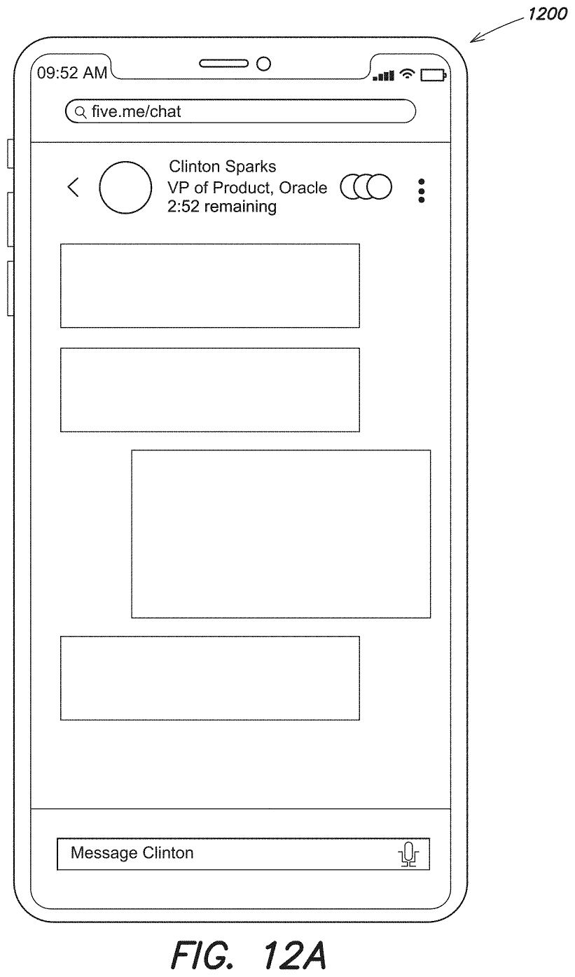

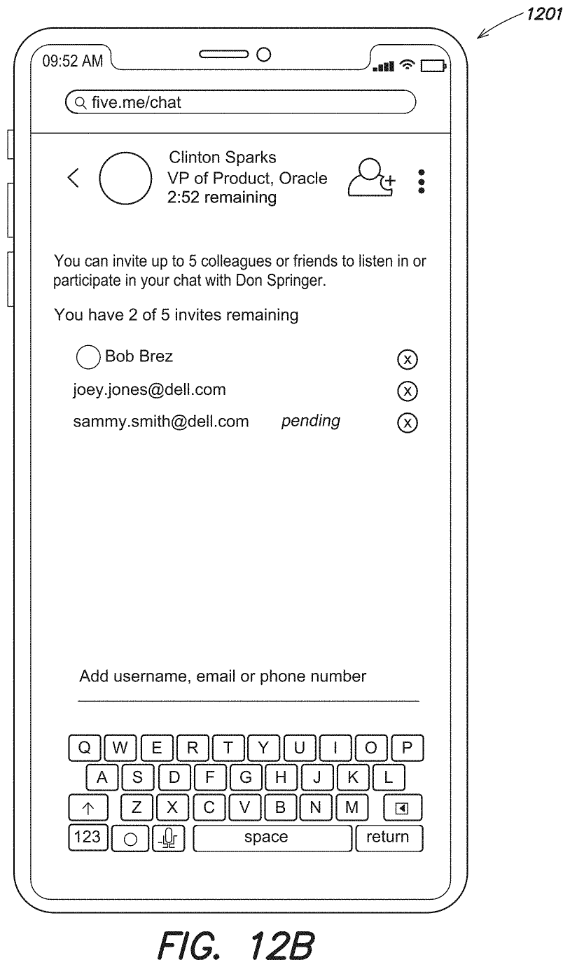

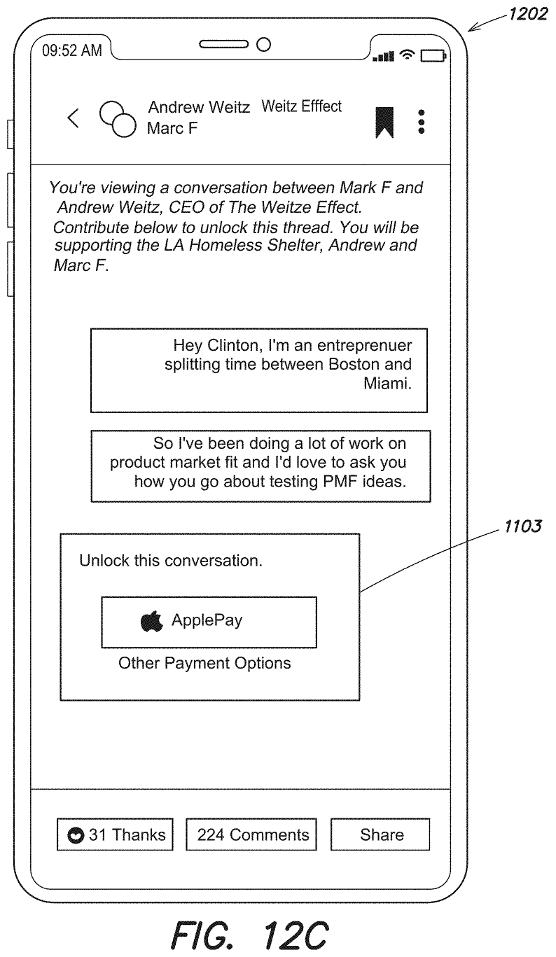

In some cases, and with various media types, the system may use various predictions for determining how much time to decrement from a particular amount of purchased time. For example, the system may measure averages for particular users to read/write text (e.g., using historic data from usage, using a statistical model, learning engine, or artificial intelligence) to determine how much a particular communication is going to reduce the amount of purchased time. For example, the system may estimate how long a user plays a video, the number of times, and decrements the amount of purchased time accordingly and updates the amount within an interface. FIG. 12A shows an example user interface 1200 used for performing asynchronous communication according to various embodiments which displays, at least in one portion of the interface, one or more media types and also displays (e.g., within the header section) the amount of time remaining for a particular conversation.

In some example implementations, a user may have the ability to invite other users to a particular conversation. For instance, a user may hire an expert and then the user is provided and ability to “invite” trusted friends, colleagues or other users into the current “private chat session” with the expert. In some embodiments, the system may or may not permit other users to type or write within the message, and in some implementations, the conversations may be read only. FIG. 12B shows an example user interface 1201 used for performing asynchronous communication according to various embodiments that permits the platform to join additional users to a conversation.

In some example implementations, the platform may allow for unlocking of conversations for particular reasons. For instance, a user may hire an expert and then the system posts a portion of the conversation onto a site or other storage entity that permits people to access the conversation. For instance, the system may post into a feed experts and user profiles related to the conversation so that people can see what questions are being asked to the expert. In some embodiments the system does not permit other users to see or read what the answers are were what the expert is saying.

In some embodiments, the system employs a feature to “unlock” a conversation that permits outside users to pay money, credits or other basis of exchange to unlock the content. By unlocking the content, the user may also be placed within a private community around that piece of content. In some implementations, that outside user still cannot access the expert or may be involved in the conversation, but the user may be permitted to communicate with any or all non-expert users who are also in the community around that piece of content. FIG. 12C shows an example user interface 1202 that may be used for performing asynchronous communication according to various embodiments, and that permits locating and unlocking a conversation (e.g., by a payment method such as ApplePay).

### Other Example Implementations

Below are further examples showing an interaction between a service provider and consumer user. In some embodiments, a process is provided where one party can communicate with another party, asynchronously, but in a time boxed entity, not open-ended like a text message or email.

Below is an example of this process where a lawyer, consultant or other type of party who typically charges an hourly rate, or retainer (or fee for time). This scenario would be for anyone who can trade information for money. For example, an ex-Navy Seal who is performing consulting and firearms training. His name is Slade, here is the example:

Slade offers 5 minutes of asynchronous time in exchange for $100.
Client discovers Slade's offering on this social media or website and engages:
Client types or records (audio or video) message
Client reviews message and goes to submit
Client pays “time-based fee”
Message is sent
   Slade receives the message:
Slade can review message and choose not to engage (and this refunds the client and sends polite decline message—in some cases or examples, the initial request may include a “pre-auth” of the customer's credit card, and payment may not be actually charged until the consultant accepts the message/job/question, etc.)
Or
If Slade accepts message
   If the message was text-based, the system is configured to estimate time to read (e.g., time per word, estimates focus of the user in the particular application, etc.)
   If audio or video, the time to “understand” may be already calculated and this time can be subtracted from the time allotted per rate/fee×# of times Slade needed to review/watch/listen. In other implementations, the actual use/listen/view time may be directly calculated (e.g., by measuring the actual view/listen time)
   Slade goes to reply via text, audio or video and that time is calculated and subtracted
   Slade could manually add research/setup time as optional
   Reply is sent
In this scenario, the following could have happened:
   Client purchased $100 for 5 minutes
   Client sends 1 minute message after paying
   Slade receives, accepts and reviews message (1 min subtracted)
      So, there are 4 minutes remaining of prepaid time
   Slade's video messages back a 1 minute, 20 second reply (1 minute, 20 seconds subtracted from the amount of time remaining)
      So 2 minutes, 40 seconds remaining
   Client receives and replies with 1 more question
   Slade receives message the next day and listens to audio message reply (30 seconds are subtracted)
      So 2 minutes, 10 seconds remaining
   Slade needed to screenshot an image, crop it and type a message reply and attach the image
      Slade typed notes=50 seconds
      Slade had option to add additional time for screen shot and attachment (1:00)
      So total of 1:50 used and now just 20 seconds remaining in this relationship
      Message sent back to client
   Client receives message
   Client has 20 seconds remaining if he chooses to use them
   The system automatically puts in thread the ability for two things
      Up your time (buy another 5 minutes for X rate (in some implementations, the cost of the time can be discounted)
      Book a Live Call (audio or video/zoom)
   Or end
   If ended, write a review
   After review
      Ask if ok to publish to public profile
      In some implementations, both parties need to opt into this
         Aspects described herein relate to several core beliefs and observations as appreciated by the inventors:
Users have moved to a heavily-preferred “async” world
   Users would rather talk via text then live on the phone . . .
   Yet users all hate voicemail (which is async)
Live communication is hard (e.g., two people need to schedule a time on a calendar for live communication to happen)
   Async functions eliminates the entire calendaring process
Video based “threading” can be stitched together for a decent “live type” experience
Audio, video, text, phone (typically “live” media types) all have their place in asynchronous communication

According to some embodiment described herein, a platform is provided that permits asynchronous communication. In some embodiments, a Consulting-based messaging (CBM) system is provided that includes one or more of the following features:
Async messaging/communications
   Live messaging/communications (the system may be programmed to handle both async and live communications and their associated charges)
Plus the time component (and how this is dynamically calculated and tracked)
Plus the fee component (and how this is dynamically calculated and tracked)

### Additional Interfaces/Functions

In some embodiments, the system may include functions within the interface that permit an expert user to perform various tasks with regard to their various communication sessions. FIGS. 5-9 show additional interface examples that may permit asynchronous activity to be tracked according to various embodiments.

### Active Sessions Screen

In some embodiments, within an “Expert” App, the expert can see a list of their “Active Sessions” with one or more users. In the example interface shown in FIG. 5, a “dashboard” or other list of active conversations may be displayed to an expert within an expert-specific interface type. As shown in FIG. 5, some sessions listed within an “active sessions” interface are “new” requests not yet accepted, some are “new replies” from previously-accepted clients and some are awaiting a reply.

In the FIG. 5 example:
Ben Uyeda is a new request not yet accept by the expert
Sara Smith is a new reply and there is 4:00 minutes remaining on her session with expert
For Cole Fackler, the expert is awaiting a reply from the user and that user has 3:35 left remaining on his session with the expert.

### Message Thread Interface

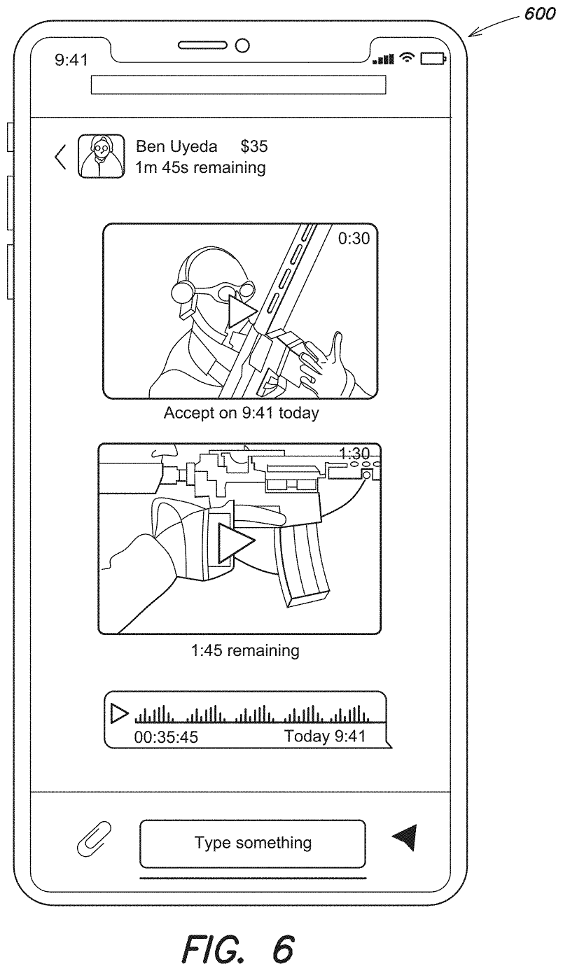

FIG. 6 shows another example interface that may be used for asynchronous communication according to various embodiments. In particular, the interface shown in FIG. 6 is displayed responsive to the user selecting a particular message thread (e.g., by clicking into a message thread). So, in the example shown, the expert would have accepted the request of Ben Uyeda and it is shown in the display that there is 1:45 remaining in the session. In some embodiments, there is an interface feature that shows remaining time “credit” to the user's account. The interface may show other information relating to the session such as a time-based activity and may include controls that permit the expert user to communicate with the user, send content, and other activities.

When the expert selects a control and enters (e.g., by clicking into a displayed thread) an individual message thread, that timer at the top (and in the thread between messages) begin “counting down”. This shows the expert very clearly that he/she is using up time in the session, so whether the expert is “reading, scrolling, typing, watching a video, looking at a photo, researching, etc.” if this thread is open the time counts down. The only time the “counter” freezes in time is when the expert leaves the thread.

Thus in this example, if the expert clicks on the back arrow which would bring the interface back to the Active Sessions screen, the new “lower” time would be stopped and frozen until the expert goes back into the thread.

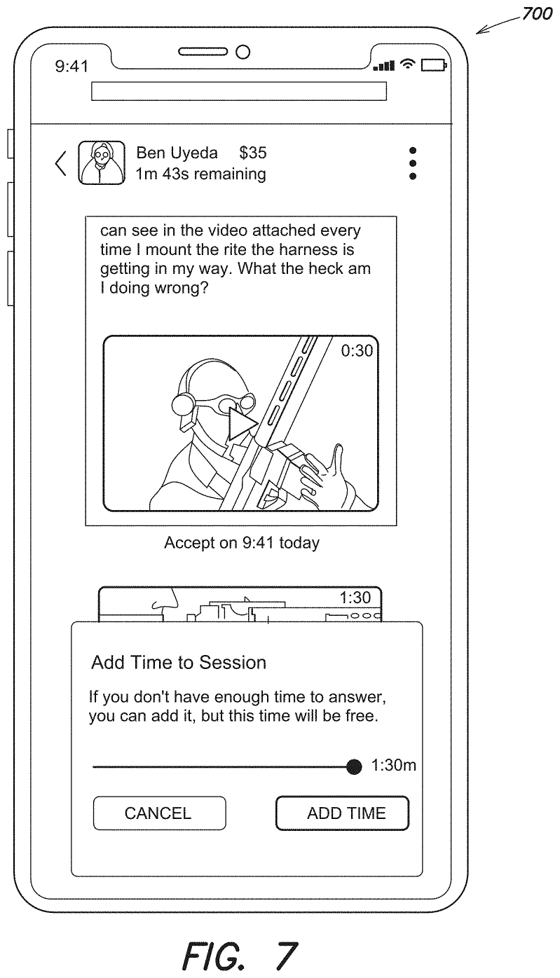

This feature, in some embodiments, may be linked with an “Add free time” module as described in more detail below and shown by way of example in FIG. 7.

### Add Free Time

As shown in FIG. 7, the expert interface may have one or more controls that permit an expert to add free time. It is appreciated that experts sometimes would take a long time to think about a reply and would feel bad about their inefficiency, so the expert may want to give some free time back to the client. With this feature, an expert can simply add more time to the current session. When they select a control (e.g., by clicking a control within the interface) to add an additional 1 minute or 1:30 or other increment, the selected time is added by the system onto the current time of the session. So, if there was 2:30 remaining in the session and the expert added 1:30, the new time in the session would be 4:00.

### Session Coming to an End

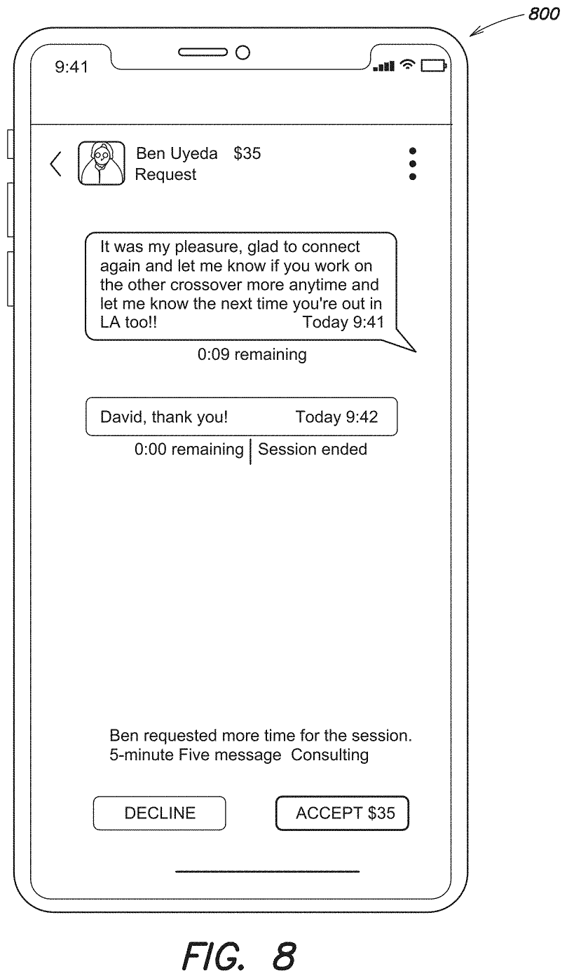

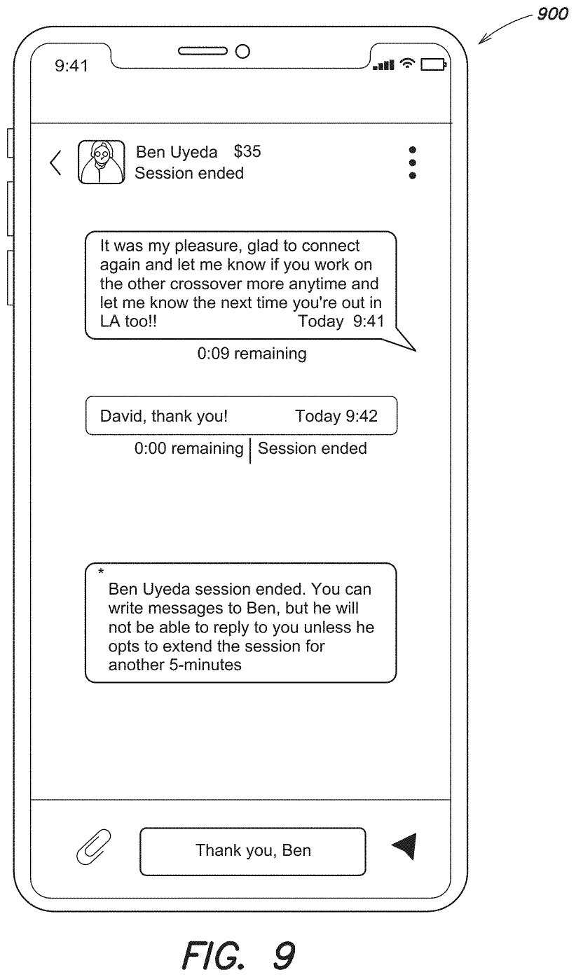

When a session is coming near to an end or the time has run out, the system, according to some embodiments, may implement “automated chat bots” to message to the client and the expert. FIG. 8 shows an example interface that may be used to extend a session. In particular, FIG. 8 shows that the client, by way of automated bot message had chosen to “extend” the session by purchasing another 5 minutes for the rate of $35. Here, in this example, the expert still needs to accept the additional (e.g., a 5-minute extension) to the session but once the user does, the same rules apply. FIG. 9 shows an example interface where the system indicates that the session has ended. In some embodiments, the system permits the expert to continue to communicate in the chat interface with the client, but the time spent is not tracked until the session is extended by the client (e.g., an payment received).

### Additional Embodiments

In some embodiments, it should be appreciated that more than one expert user can attend a session and/or be performing asynchronous communication for which could be paid for by a user. Also, more than one user that benefits from the expert services may be permitted to enter a session. For instance, the system may include an interface that permits additional users to enter a session (and deduct time from a predetermined amount for the session). For instance, in some embodiments, an ability and interface controls may be provided to the user who hires the expert to invite colleagues/peers, etc. into the paid session. For instance, such additional users may be permitted to read/write to the session, or the session may be a read-only session (e.g., the added user may be a “fly-on-the wall”).

In another example, an expert may be permitted to bring one or more other experts into the session. In some cases, the system may be configured to track individual efforts of the experts, track split-fee arrangements, or automatically determine chargebacks through these and other methods. For example, if a user was chatting with Tom Brady and he wanted to bring in Gronk to talk about Tight End position, Tom could pull Gronk into the paid session (e.g., via an interface control) and the system could handle a fee split to pay both Tom and Gronk accordingly.

In other implementation options, a user that hires a particular expert within the application may earn “royalties” on the content created through their session. In some embodiments, once the conversation for a particular session is over, participants who wish to read/view the content may pay for access, or in some instances, the original user may opt to post the content created. In one example scenario:
User 1 pays $100 and hires Expert to ask patent-related questions
Once the conversation is over, a portion of the conversation could be posted behind a paywall.
In one example implementation, the system just shows a portion of the conversation (e.g., the opening question).
Then users could subscribe or pay once to get access to that “conversation” between User 1 and the Expert
The system handles royalty payments between parties (1) expert, (2) user who asked the question, and in some embodiments, (3) the platform that monetizes the content
In some embodiments, the content can be handled using a blockchain, or it can be handled separately from the blockchain

### Example Computer System

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having thus described several aspects of at least one embodiment of this invention, it is to be appreciated various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

What is claimed is:

1. A system comprising:
an end user application that permits an asynchronous communications between a service provider user and a consumer user;
a time-based component that is configured to calculate a time of use by the service provider user of the end user application; and
a billing component adapted to charge a user based on the calculated time of use.

2. The system according to claim 1, wherein the end user application is at least one of a group comprising:
a chat application;
a messaging application;
a conferencing application; and
an application by which the service provider user creates content.

3. The system according to claim 1, wherein the system further comprises at least one user interface that is adapted to display the time of use by the service provider user of different end user applications.

4. The system according to claim 1, further comprising a first end system adapted to execute a first end user application, the first end user application being operable to receive content generated by the service provider user.

5. The system according to claim 4, wherein the time-based component is adapted to map activity of the service provider user within the first end user application into at least one billing contract between the service provider user and the consumer user.

6. The system according to claim 4, further comprising a component configured to measure activity of the service provider user within the first end user application.

7. The system according to claim 6, wherein the component that measures the activity of the service provider user includes at least one of a group comprising:
a component configured to estimate activity based on heuristics;
a component adapted to learn activity responsive to training;
a component configured to estimate activity based on statistical methods; and
a component configured to estimate activity based on content shared within the first end user application.

8. The system according to claim 6, wherein the component that measures the activity of the service provider user includes a timer that is adapted to count down responsive to a detection of presence of activity of the service provider user within the first end user application.

9. The system according to claim 8, wherein the timer is adapted to stop counting down responsive to a detection of an absence of presence of activity of the service provider user within the first end user application.

10. The system according to claim 8, wherein the timer is adapted to count down responsive to a determination that the service provider user is operating within an active viewport of the first end user application.

11. The system according to claim 8, wherein the timer is adapted to count down responsive to an activation of a control by the service provider user within the first end user application.

12. The system according to claim 8, wherein the timer is adapted to count down responsive to an activation of a second end-user application executing on the first end system.

13. The system according to claim 12, wherein the second end-user application includes at least one of a group comprising:
a chat application;
a messaging application;
a conferencing application; and
an application by which the service provider user creates content.

14. The system according to claim 13, wherein the time-based component and billing component are separate from the second end-user application.

15. The system according to claim 14, wherein the time-based component and billing component are integrated into multiple end-user applications to measure the activity of the service provider user.

16. The system according to claim 9, wherein the timer is adapted to stop counting down responsive to a detection of the service provider leaving an active communication thread between the service provider user and the consumer user.

17. The system according to claim 9, wherein the timer is adapted to stop counting down responsive to a detection of an interruption within the interface of the first end system.

18. The system according to claim 1, wherein the end user application includes at least one interface control that permits either the service provider user or the consumer user to invite another user to join the asynchronous communications.

19. The system according to claim 1, wherein the end user application includes at least one interface control that permits a third party user to access the asynchronous communications between the service provider user and the consumer user.

20. The system according to claim 1, wherein the end user application includes at least one interface control that permits a third party user to access a message thread between the service provider user and the consumer user.

21. The system according to claim 4, further comprising a second end system adapted to execute a second end user application, the second end user application being operable to display content generated by the service provider user to the consumer user.

22. A method comprising acts of:
executing, by a first end system, a first end user application being operated by a service provider user;
executing, by a second end system, a second end user application being operated by a consumer user; and
managing asynchronous communication between the first end user application and the second end user application, the act of managing further comprising acts of:
calculating, by a time-based computing entity, a time of use by the service provider user of the first end user application; and
charging, by a computer-based billing entity, the consumer user based on the calculated time of use.
